(19) United States
(12) Patent Application Publication
(10) Pub. No.: US 2008/0223424 A1
(43) Pub. Date: Sep. 18, 2008

(54) Upper arm crutch

(76) Inventor: Michael D. Hollier, Houston, TX (US)

Correspondence Address: Michael D. Hollier, 1915 Pepper Hill Way, Houston, TX, 77058, US

(21) Appl. No.: 11/724,669

(22) Filed: Mar. 16, 2007

(51) Int. Cl. A61H 3/02

(52) U.S. Cl. 135/71; 135/72; 135/73

(57) ABSTRACT

The invention, referred to as the Upper Arm Crutch, pertains to crutches used by the disabled to facilitate walking. The Upper Arm Crutch allows the user's weight to be supported with the arm straight, reducing fatigue. The design of the arm band is such that the arm band will not inadvertently slip off the arm, yet can be removed readily by rotating the crutch handle 45 degrees in either direction. The single arm band encloses the upper arm, instead of the forearm, increasing leverage and control. The single arm band is positioned well below the armpit. The user is not inclined to support their weight by leaning on the arm bands. The design of the arm band allows the user's arm to be positioned directly above the handle such that the crutch does not tilt when weight is applied to the handle.

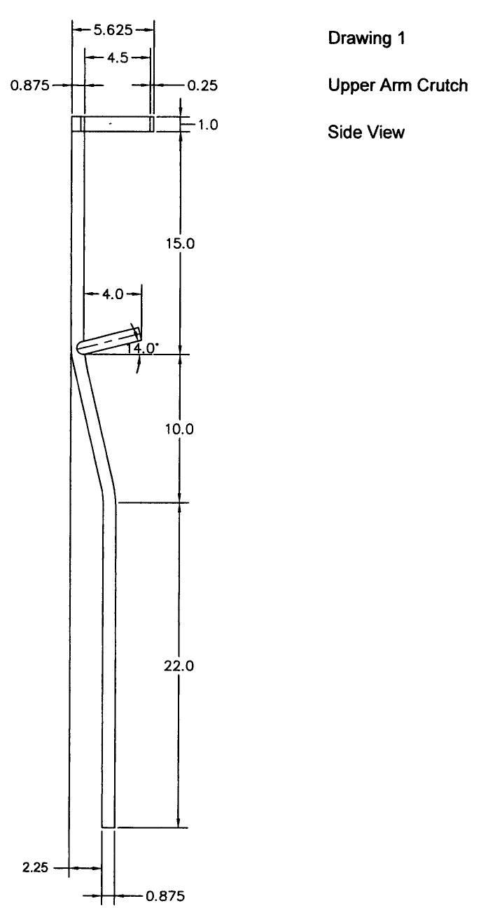

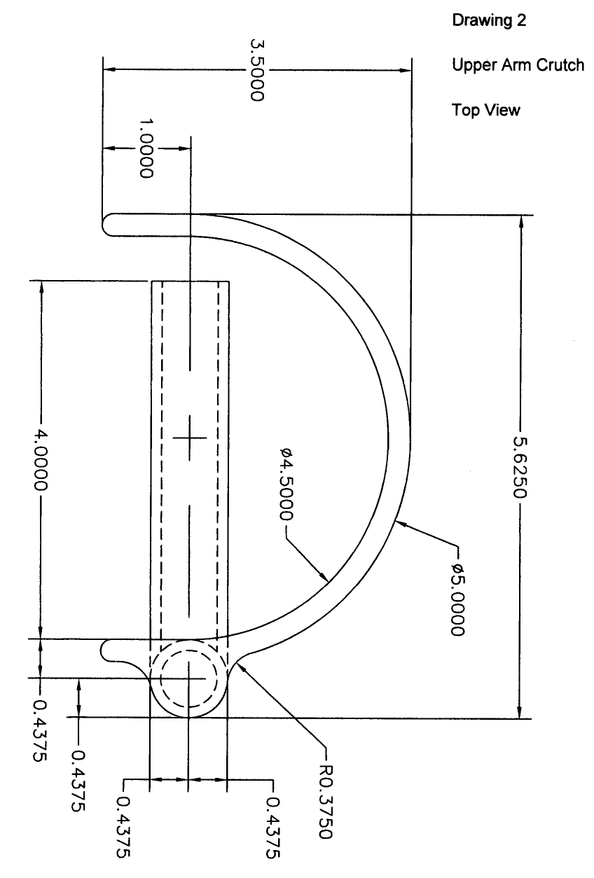

### BACKGROUND OF THE INVENTION

My name is Michael D. Hollier. I have walked on crutches since contracting polio in 1950. For individuals suffering paralysis or injuries to the lower extremities, there are two types of crutches commonly in use today, the underarm crutch, and the forearm crutch. Both of these designs suffer from several significant deficiencies. The present invention is intended to mitigate the deficiencies inherent in contemporary crutch designs.

The following deficiencies are inherent in the design of the underarm crutch:

1. Underarm crutches rub the armpits raw, because users tend to rely on the underarm portion of the crutch to support the body weight. Long term use of the underarm portion of the crutch to support the body weight has been linked to nerve damage in the arms.

2. Since the upper part of the underarm crutch is not fixed to the user's arm in any way, it easily slips out from under the arm, toward the front, or toward the back. The underarm crutch is particularly likely to slip out from under the arm when navigating up or down stairs, or negotiating an incline. This may result in a fall.

3. The most common cause of falls, when using crutches, is due to the crutch tip slipping when walking on wet surfaces. Since the upper part of the underarm crutch is not attached to the user's arm, when the crutch tip slips, there is no way to apply compensating leverage to arrest the skid. Any attempt to apply leverage between the handle and the upper portion of the crutch may cause the upper portion of the crutch to slip out from under the arm, possibly resulting in a fall.

4. The underarm crutch does not permit the user's weight to be supported with the arm straight at the elbow. Since the upper cross piece is centered directly above the handle, the user's upper arm must of necessity be outboard of the cross piece. Therefore the upper arm and elbow are outboard of the handle. The arm must be bent slightly at the elbow in order to grasp the handle. The user's weight must be supported with the arm flexed at the elbow, leading to rapid fatigue.

The following deficiencies are inherent in the design of the forearm crutch:

1. The forearm crutch is even less satisfactory than the underarm crutch. The geometry employed in the design of the forearm crutch is faulty.

2. The upper tube, located above the handle, is inclined toward the rear. This forces the user's arm into a flexed position at the elbow. The user's weight must be supported with the arm bent at the elbow rather than straight. Using forearm crutches requires more strength in the arms than is common in must crutch users, particularly in the triceps. As a result, the user rapidly becomes fatigued.

3. The handle on a forearm crutch is generally attached at a right angle to the lower tube. Since the upper tube is inclined at an angle relative to the crutch handle, the user's hand tends to migrate forward on the handle. When the handle is slippery, due to rain or perspiration, the hand tends to slip off the front of the handle.

4. In other embodiments of the forearm crutch, the handle is attached at a right angle to the upper tube, instead of the lower tube. This configuration prevents the hand from migrating forward toward the end of the grip, but fails to preserve the correct ergonomic angle between the wrist and forearm.

5. The center of the handle on the forearm crutch is in front of the crutch tip. When weight is applied to the handle, this configuration places the downward center of effort through the handle, in front of the upward center of resistance of the crutch tip. This causes the crutch to tilt forward. This phenomenon is particularly unsettling, even frightening, when attempting to go down a flight of stairs. When walking on forearm crutches, the user must constantly compensate for the tendency of the crutch to tilt forward when weight is applied to the handle. The propensity of the crutch to tilt forward also causes the arm band to exert an excessive and uncomfortable amount of pressure to the back of the forearm.

6. The forearm crutch enjoys a slight advantage over the underarm crutch when recovering from a slip since the arm band generally encloses the rear and both sides of the forearm. However, slips most commonly occur on the forward step, which results in the direction of the skid being forward. To recover when the crutch tip slips in the forward direction, the user must compensate by applying pressure to the rear on the crutch handle. In this situation, the rearward pressure on the handle causes the forearm crutch to tilt backwards, and off the forearm. This could result in a fall.

7. Another deficiency of the forearm crutch design is the fact that the arm band, in order to enclose the forearm, must be placed in relatively close proximity to the handle. The distance the arm band can be positioned above the handle is limited by the length of the individual's forearm. This limits the amount of leverage available to manipulate the crutch and recover from slips.

The present invention, referred to as the Upper Arm Crutch, was conceived to solve the problems inherent in the current crutch technology. My goal was to design the ultimate crutch. The design had to meet the following criteria:
1. The crutch must be easy to fabricate.
2. The crutch must support the user's weight with the arm straight at the elbow, to minimize fatigue.
3. The arm band must be designed so that it will not slip off the user's arm.
4. The arm band must enclose the arm above the elbow to afford greater leverage.
5. The arm band must not rub under the armpits.
6. The arm band must be designed so that the user's arm can be positioned directly above the center of the handle, preventing the crutch from tilting under load.
7. The arm band must not exert undue pressure on the arm.
8. The handle must be designed so that the user's hand will not slip off the handle.
9. The handle must maintain the wrist at the ergonomically correct angle.
10. The handle must be positioned directly above the crutch tip.
11. The crutch must be neutrally stable. It must not tilt when weight is applied.

### BRIEF SUMMARY OF THE INVENTION

The present invention, referred to as the Upper Arm Crutch, is a simple design, intended to mitigate the inherent deficiencies of the underarm crutch and the forearm crutch. The Upper Arm Crutch incorporates only three basic parts, a vertical component with a dogleg bend in it, a handle, and a single C shaped arm band.

The arm band encloses the upper arm on the front, inside, and rear. The opening of the arm band is oriented toward the outside of the upper arm. The arm band will not slip off the arm. The arm band encloses the upper arm above the elbow in order to afford greater leverage for manipulating the crutch.

The handle is located directly below the center of the arm band such that the user's weight can be supported with the arm straight at the elbow, minimizing fatigue. The handle projects from the rear of the vertical component, as the Upper Arm Crutch is specifically designed to be worn with the vertical component facing toward the front, and the handle projecting toward the rear. A dogleg bend in the vertical component, below the handle, places the crutch tip below the center of the handle. The crutch will not tilt when weight is applied. The handle is attached to the vertical component with the free end inclined upward at an angle, causing the hand to migrate toward the front of the handle, until its forward motion is limited by the vertical component. The hand will not slip off the handle. The upward slant of the handle preserves the proper ergonomic angle between the wrist and forearm.

### BRIEF DESCRIPTION OF THE DRAWINGS

Drawing 1 is a side view of an embodiment of the Upper Arm Crutch. The dogleg bend in the vertical component below the handle places the crutch tip below the center of the handle. The dimensions are appropriate for an average sized person. A person practiced in the art of fabricating crutches will realize that the dimensions for a given pair of crutches will be determined by measurements taken from the actual patient. The dimension between the top of the handle and the arm band must be such that the arm band encircles the upper arm two or three inches above the elbow. A practitioner of the art will also most likely know to fit crutch tips, and perhaps rubber hand grips, even though they are not shown on the drawing.

Drawing 2 is a top view of an embodiment of the Upper Arm Crutch. The Upper Arm Crutch is specifically designed to be used with the vertical component toward the front, and the handle and arm band projecting toward the rear. The C shaped arm band is oriented with the opening toward the outside of the arm. The handle is directly below the center of the arm band such that the user's weight can be supported with the arm straight at the elbow. The dimensions are appropriate for an average sized person. A person practiced in the art of fabricating crutches will realize that the dimensions for a given pair of crutches will be determined by measurements taken from the actual patient. The drawing depicts the arm band in the proper orientation for the crutch that would be used on the right arm. The arm band on the crutch for the left arm would be opposite hand.

### DETAILED DESCRIPTION OF THE INVENTION

The invention, referred to as the Upper Arm Crutch, is intended to mitigate the deficiencies of the traditional underarm crutch and forearm crutch, while simultaneously being easily fabricated. Disregarding commonly install appurtenances, such as crutch tips, or rubber hand grips, the Upper Arm Crutch is assembled from only three basic parts, the vertical component, the handle, and the C shaped arm band.

The components of the Upper Arm Crutch can be composed of any material commonly employed in the fabrication of crutches, such as metal, wood, or plastic. The prototype Upper Arm Crutch was constructed using aluminum tubing. The arm band was machined from a solid billet of aluminum plate.

The first step in the process is to fabricate the vertical component with a dogleg bend, such that the upper portion of the vertical component is offset to one side of the lower portion by two and a quarter inches. Refer to drawing number 1 for the location of the bends in the vertical component. The top and bottom of the vertical component must remain parallel to each other. The purpose of the offset in the vertical component is to place the crutch tip under the center of the handle, and to place opening in the arm band above the center of the handle. This allows the user to walk on the crutch with the arm straight at the elbow, and causes the weight to be transferred directly down into the center of the crutch tip. This configuration also prevents the crutch from tipping when weight is applied to the handle. Since the crutch does not tip, the arm band does not apply undue pressure on the arm, as is the case with the traditional forearm crutch. This configuration also reduces the onset of fatigue, as the user's weight is supported with the arm straight at the elbow, rather than slightly flexed, as is the case with traditional crutch designs.

The second step is to fabricate the crutch handle and attach the handle to the vertical component above the dogleg. A person practiced in the art of fabricating crutches, will use their method of choice for attaching the handle to the vertical component. The method for attaching the handle will be dependent on the material employed in the fabrication of the crutch. Attach the handle such that the free end is inclined upwards at a fourteen degree angle. The Upper Arm Crutch is specifically designed and intended to be used with the vertical component facing forward, and the handle and arm band projecting to the rear. The incline in the handle will cause the hand to migrate forward until it contacts the vertical component. The vertical component prevents the hand from slipping forward off the handle, as can be the case with the traditional forearm crutch. This also centers the hand above the crutch tip, such that the downward center of effort is directly above the upward center of resistance of the crutch tip. The crutch will not tend to tip or tilt when weight is applied, as is the case with the traditional forearm crutch. The upward incline of the rear projecting handle, results in approximately the correct ergonomically angle between the wrist and forearm.

Fabricate the arm band and attach it to the top of the vertical component. Refer to drawing 2 for the dimensions of the arm band. In the case of a custom crutch, the inside diameter of the arm band, may be derived from a measurement of the diameter of the patient's upper arm. The arm band on the prototype crutch is machined from a solid billet of aluminum. On a mass produced crutch, the arm band might be composed of injection molded plastic, or shaped from steel. A person practiced in the art of fabricating crutches, will use their method of choice to attach the arm band to the upper tube. The method for attaching the arm band to the vertical component would be dependant on the choice of materials used for fabricating these parts. The C shaped arm band must be attached to the upper end of the vertical component, centered directly above the handle, and with the open side of the C parallel to the handle, exactly as depicted in drawing 2.

This configuration allows the user's weight to be supported with the arm straight at the elbow, minimizing fatigue. The length of the vertical component, between the handle and the bottom of the arm band, must be such that it places the bottom of the arm band approximately two inches above the elbow. Placement of the arm band two inches above the elbow maximizes the amount of leverage that can be applied to manipulate the crutch. This configuration affords the user significantly more leverage than that available with the traditional forearm crutch. Simultaneously, this places the arm band sufficiently below that armpit that it does not rub, and the user is not encouraged to lean on the arm bands, as is the case with the traditional underarm crutch.

1. An Upper Arm Crutch for use by persons suffering from lower extremity disability comprising: (a) a single vertical component with a dogleg bend in it; (b) a handle attached to the vertical component, centered above the dogleg bend, and projecting from the rear of the vertical component, inclined upward at an angle of 14 degrees; (c) a C shaped arm band attached to the top of the vertical component and projecting toward the rear, such that it is centered above the handle with the open side of the C parallel to the handle.

2. The Upper Arm Crutch of claim 1 wherein the crutch is fabricated from any material commonly utilized in the fabrication of crutches.

3. The Upper Arm Crutch of claim 1 wherein the dogleg bend in the vertical component places the crutch tip directly below the center of the crutch handle.

4. The Upper Arm Crutch of claim 1 wherein the crutch is specifically designed to be used with the vertical component toward the front.

5. The Upper Arm Crutch of claim 1 wherein the crutch is specifically designed to be used with the handle and arm band projecting toward the rear.

6. The Upper Arm Crutch of claim 1 wherein the center of the crutch handle is positioned directly above the crutch tip.

7. The Upper Arm Crutch of claim 1 wherein the free end of the crutch handle is inclined upwards toward the rear at an angle of 14 degrees.

8. The Upper Arm Crutch of claim 1 wherein the crutch handle is attached to the vertical component utilizing any method commonly employed for attaching one object to another, such as, but not necessarily limited to, welds, bolts, screws, rivets, or adhesives.

9. The Upper Arm Crutch of claim 1 wherein the C shaped arm band projects toward the rear of the vertical component.

10. The Upper Arm Crutch of claim 1 wherein the C shaped arm band encloses the users arm approximately two inches above the elbow.

11. The Upper Arm Crutch of claim 1 wherein the C shaped arm band encloses the users arm approximately six inches below the armpit.

12. The Upper Arm Crutch of claim 1 wherein the C shaped arm band is oriented such that the open side of the C is on the outside of the user's arm.

13. The Upper Arm Crutch of claim 1 wherein the C shaped arm band is oriented such that the open side of the C is parallel to the crutch handle.

14. The Upper Arm Crutch of claim 1 wherein the C shaped arm band is centered directly above the crutch handle.

15. The Upper Arm Crutch of claim 1 wherein the C shaped arm band is attached to the top of the vertical component utilizing any method commonly employed for attaching one object to another, such as, but not necessarily limited to, welds, bolts, screws, rivets, or adhesives.
